(19) United States
(12) Patent Application Publication
(10) Pub. No.: US 2025/0009165 A1
(43) Pub. Date: Jan. 9, 2025

(54) COFFEE MACHINE AND COFFEE EXTRACTION METHOD WITH SUCH A COFFEE MACHINE

(71) Applicant: DE' LONGHI APPLIANCES S.r.l., Treviso (IT)

(72) Inventors: Paolo EVANGELISTI, Treviso (IT); Alberto ACCIARI, Treviso (IT); Nicola PIOVAN, Treviso (IT); Davide BONOTTO, Treviso (IT)

(73) Assignee: DE' LONGHI APPLIANCES S.r.l., Treviso (IT)

(21) Appl. No.: 18/709,768

(22) PCT Filed: Nov. 14, 2022
(86) PCT No.: PCT/EP2022/081721

§ 371 Date: May 13, 2024

(30) Foreign Application Priority Data
Nov. 18, 2021 (IT) 102021000029165

(51) Int. Cl. A47J 31/52; A47J 31/54; A47J 31/56

(52) U.S. Cl. CPC A47J 31/5253; A47J 31/545; A47J 31/56

(57) ABSTRACT

A coffee extraction method with a coffee machine comprising an infusion circuit comprising a supply pump, an electric heater and an infusion unit having an infusion chamber where a dose of coffee powder can be positioned, connected in sequence, wherein the machine stores a plurality of selectable extraction cycles each including in sequence an infusion circuit heat regulation step, a step of introducing said dose into said infusion chamber, and a step of extracting coffee having an initial coffee extraction temperature value, and after acquiring a selection of a coffee extraction cycle, compares the value of a temperature along the infusion circuit with the initial extraction temperature value of the selected extraction cycle, and performs the heat regulation step by activating the supply pump to generate a heat regulation water flow until the detected temperature value achieves the initial extraction temperature value of the selected extraction cycle.

### CROSS-REFERENCE TO RELATED APPLICATIONS

This is a U.S. National Phase Application under 35 U.S.C. 371 of International Patent Application No. PCT/EP2022/081721, filed Nov. 14, 2022, which claims benefit of priority to Italian Patent Application No. 102021000029165, filed Nov. 18, 2021. The entire contents of these applications are hereby incorporated by reference.

### FIELD OF THE INVENTION

The present invention refers to a coffee machine and to a coffee extraction method with such a coffee machine.

### BACKGROUND

Automatic coffee machines capable of preparing both espresso beverages obtained at high pressure with cream formation and “drip” or American coffee beverages obtained at low pressure without cream formation are known.

In general, such coffee machines are provided with an infusion circuit having in cascade a water tank or a connection to a water source, a water supply pump, a boiler and an infusion unit where a dose of coffee powder is positioned.

The water that the pump draws from the tank or from the water mains is heated by the boiler and supplied to the infusion unit where it extracts the aromatic substances from the coffee powder.

For the espresso coffee beverage to be prepared throughout the infusion time, the dose of coffee is pressed inside the infusion chamber of the infusion unit and the coffee beverage leaving the infuser passes through a cream frother valve whose purpose is to increase the outlet pressure of the coffee beverage so as to generate turbulences in the flow, with consequent formation of air bubbles and foam.

For the “drip” coffee beverage to be prepared throughout the infusion time, the dose of coffee is not pressed inside the infusion chamber of the infusion unit and the coffee beverage leaving the infuser by-passes the cream frother valve.

In the coffee sector, the appreciation of other types of coffee beverages is spreading among consumers, including the so-called “cold brew” coffee.

“Cold brew” coffee is a type of beverage that requires the consumer to add ice cubes to the product dispensed in the cup until the desired result is obtained.

The organoleptic properties of “cold brew” coffee depend significantly on the extraction temperature.

Generally, coffee machines currently on the market for the preparation of a “cold brew” coffee are not able to control the process variables, with consequent deterioration of the organoleptic properties of the product in the cup.

In addition, the coffee machines currently on the market for the preparation of a “cold brew” coffee exhibit a lack of versatility in use as they are not able to customize the product dispensed. The technical task of the present invention is to overcome the drawbacks complained of by the prior art.

As part of this technical task, an object of the present invention is to realize a coffee extraction method and a coffee machine by means of which a variety of coffee recipes can be made while always ensuring the desired organoleptic properties of the product in the cup.

Another object of the present invention is to realize a coffee extraction method and a coffee machine by means of which both espresso coffee and “drip” coffee and “cold brew” coffee can be prepared.

### SUMMARY

The technical task, as well as this and other objects are achieved by the present invention which discloses a coffee extraction method with a coffee machine comprising an infusion circuit at least including a water tank or a connection to a water source, a supply pump, an electric heater and an infusion unit having an infusion chamber where a dose of coffee powder can be positioned, connected in sequence, characterized in that said machine stores a plurality of selectable extraction cycles each including in sequence an infusion circuit heat regulation step, a step of introducing said dose into said infusion chamber, and a step of extracting coffee having an initial coffee extraction temperature value, and in that, after acquiring a selection of a coffee extraction cycle, the coffee machine detects the value of a temperature along the infusion circuit, compares said detected temperature value with the initial extraction temperature value of the selected extraction cycle, and performs the heat regulation step by activating the supply pump to generate a heat regulation water flow until said detected temperature value achieves said initial extraction temperature value of the selected extraction cycle.

Preferably an instantaneous boiler is employed as the electric heater.

Preferably said coffee machine conveys said heat regulation water flow in sequence at least through said electric heater and said infusion unit.

Preferably said coffee machine detects said temperature value at an inlet or an outlet of said electric heater.

In one embodiment of the invention said coffee machine performs said heat regulation step by activating said electric heater for heating said heat regulation water flow only if said detected temperature value is lower than said initial coffee extraction temperature of the selected coffee extraction cycle.

In one embodiment of the invention, at least one coffee extraction cycle envisages the activation of said electric heater throughout said extraction step for the maintenance of said initial extraction value during said extraction step.

In one embodiment of the invention, at least one coffee extraction cycle envisages the deactivation of said electric heater throughout said extraction step.

In one embodiment of the invention at least one extraction cycle envisages an initial extraction temperature value equal to room temperature.

In one embodiment of the invention at least one extraction cycle envisages an initial extraction temperature value comprised between 50° C. and 60° C.

In one embodiment of the invention at least one extraction cycle envisages an initial extraction temperature value comprised between 90° C. and 95° C.

The present invention also discloses a coffee machine comprising an electronic controller, an infusion circuit and sensor means of a temperature along said infusion circuit, where said infusion circuit comprises a water tank or a connection to a water source, a supply pump, an electric heater and an infusion unit having an infusion chamber where a dose of coffee powder can be positioned, connected in sequence, characterized in that said electronic controller has in its memory a plurality of selectable coffee extraction cycles each including in sequence an infusion circuit heat regulation step, a step of introducing said dose into said infusion chamber, and a coffee extraction step having an initial coffee extraction temperature value, and in that said electronic controller is configured to:
acquire a selection of a coffee extraction cycle;
acquire the value of the temperature detected by said sensor means
compare said detected temperature value with the initial extraction temperature value of the selected extraction cycle; and
perform said heat regulation step by activating the supply pump for generating a heat regulation water flow until said detected temperature value achieves said initial extraction temperature value of the selected extraction cycle.

In one embodiment of the invention said infusion circuit further comprises a coffee infusion dispensing conduit, a first connection conduit between a delivery of the supply pump and an inlet of the electric heater, a second connection conduit between an outlet of the electric heater and an inlet of the infusion unit, a valve unit, a third connection conduit between an outlet of the infusion unit and an inlet of the valve unit, said valve unit being configured to provide a first outlet path at high pressure comprising a back pressure means and a second outlet path at low pressure comprising a bypass means selectively activatable by the electronic controller for bypassing the action of said back pressure means and making the beverage pass into said second outlet path.

In one embodiment of the invention said first connection conduit, said electric heater, said second connection conduit, said infusion unit, said third connection conduit and said valve unit are connected to be crossed in sequence by said heat regulation water flow.

According to the invention the extraction of “cold brew” coffee at the desired temperature can be obtained, since the preliminary control and regulation of the temperature of the components of the infusion circuit through the heat exchange due to the heat regulation water flow is added to the control and to the regulation of the temperature of the infusion water.

In the preferred solution, the heat regulation water flow is disposed of through the discharge conduit, but it is not ruled out that it can be disposed of through the infusion dispensing conduit in such a way as to have a substantial homogenization of the temperature along the entire hydraulic circuit before the extraction step is performed.

In this regard, it should also be noted that the adoption of an instantaneous boiler as an electric heater, otherwise known as a “flow through heater”, greatly facilitates obtaining the initial extraction temperature with a modest amount of heat regulation water.

### BRIEF DESCRIPTION OF THE DRAWINGS

Further features and advantages of the invention will more fully emerge from the description of a preferred, but not exclusive embodiment thereof, according to the invention illustrated by way of non-limiting example in the drawings in which:

FIG. 1 shows a diagram of the hydraulic circuit of the coffee machine; and

FIG. 2 shows the time control logic of the temperature in various coffee extraction cycles.

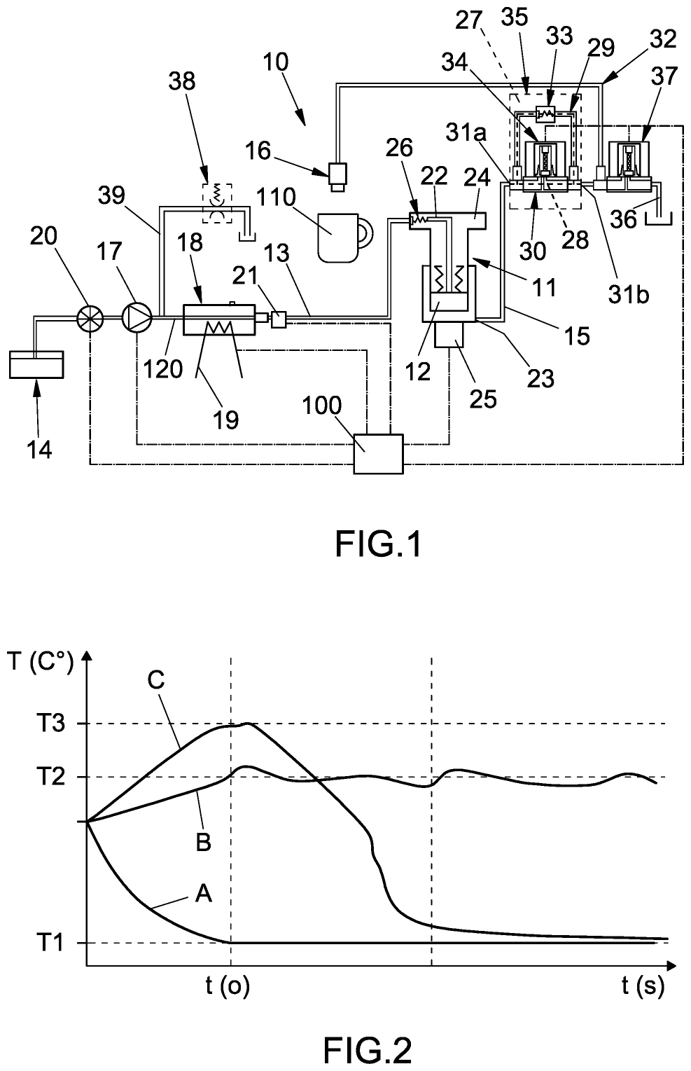

### DETAILED DESCRIPTION

With reference to the figures, the automatic coffee machine 10 comprises an electronic controller 100 and an infusion circuit that includes: a water source 14, in the specific case a water tank, or a connection to a water source, for example a connection to the water mains: a supply pump 17: an electric heater 18, particularly an instantaneous boiler provided with one or more electric resistors 19; a first connection conduit 120 between a delivery of the supply pump 17 and an inlet of the electric heater 18: an infusion unit 11 provided with an infusion chamber 12 suitable for containing a dose of coffee powder to be infused, where the infusion chamber 12 has an inlet opening 22 and an outlet opening 23: a second connection conduit 13 between an outlet of the electric heater 18 and the inlet opening 22 of the infusion unit 11: a valve unit 35 provided with an inlet 31a and an outlet 31b; and a third connection conduit 15 between the outlet opening 23 of the infusion chamber 12 and the inlet 31a of the valve unit 35.

The inlet opening 22 and the outlet opening 23 of the infusion chamber 12 are preferably made one on a fixed body 24 and the other one on a movable piston 25.

The infusion circuit further comprises a dispensing valve 26 placed upstream of the inlet opening 22 of the infusion chamber 12, configured to keep the inlet opening 22 of the infusion chamber 12 closed until the supplied water exceeds a certain pressure value, and open it upon exceeding this value.

By way of example, the dispensing valve 26 can be configured to counteract a maximum pressure of about 3 bar, preferably comprised between 1 and 3 bar.

The dispensing valve 26 may also be configured to act as a non-return valve, so as to prevent a retrograde flow from the infusion chamber 12.

The valve unit 35 downstream of the infusion chamber 12 is configured to define a first outlet path 27 at high pressure and a second outlet path 28 at low pressure.

The inlet 31a of the valve unit 35 is connected to the outlet opening 23 of the infusion chamber 12 and the outlet 31b of the valve unit 35 is connected to a beverage dispensing conduit 32 in turn connected to a dispensing nozzle 16 by means of which the coffee infusion can be dispensed into a container 110.

The valve unit 35 comprises a back pressure means 33 adapted to provide a certain back pressure force and a bypass means 34 selectively activatable to bypass the action of the back pressure means 33.

In the solution illustrated by way of example, the path at high pressure 27 and the path at low pressure 28 are respectively defined by a first branch 29 and by a second branch 30, which are distinct from each other, and which extend between the inlet 31a and the outlet 31b.

According to such an embodiment, the back pressure means comprises a cream frother valve 33 arranged along the first branch 29 and configured to allow the beverage to pass through it only if the pressure exceeds a defined threshold value.

By way of example, the cream frother valve 33 can be configured to counteract a maximum pressure of about 3 bar, preferably comprised between 1 and 3 bar.

The bypass means may comprise a shut-off valve 34 arranged along the second branch 30 that can be selectively controlled to open or close a passage conduit and allow, or respectively prevent, the beverage to pass therethrough.

The shut-off valve 34 may be, for example, a solenoid valve.

The coffee machine 10 also has a special sensor means 21 of a temperature along the infusion circuit, preferably placed upstream or, as shown, downstream of the electric heater 18 and in particular between the electric heater 18 and the infusion unit 11.

A flowmeter 20 may also be provided along the infusion circuit, preferably placed upstream of the supply pump 17.

The machine 10 may also comprise a self-triggering valve 38 arranged along a conduit 39 placed downstream of the pump 17 and in derivation with the first connection conduit 120.

The self-triggering valve 38 can be made as a sleeve valve, or a “pinch” valve.

Finally, the machine 10 also comprises a discharge conduit 36 for the residual water deriving from the exhausted coffee powder.

The discharge conduit 36 may be made in derivation of the dispensing conduit 32 and be kept normally closed by means of a discharge solenoid valve 37 arranged along it.

The coffee extraction method is as follows.

The electronic controller 100 has in memory a plurality of coffee recipes and an association to each recipe of a corresponding coffee extraction cycle executable from the coffee machine.

Each coffee extraction cycle advantageously comprises in sequence an infusion circuit heat regulation step, a step of introducing the dose of coffee powder into the infusion chamber 12, and a step of extracting coffee having an initial coffee extraction temperature value Ti (where i=1, 2, 3, . . . ).

The electronic controller 100, after having acquired from the consumer, for example through a machine/user interface, a selection of a recipe, performs the extraction cycle associated therewith.

In practice, the electronic controller 100 acquires the temperature value T detected by the sensor means 21, compares the temperature value T detected with the initial extraction temperature value Ti of the selected extraction cycle, and performs the heat regulation step by activating the supply pump 17 for generating a heat regulation water flow until the value T of the detected temperature achieves the initial extraction temperature value Ti of the selected extraction cycle. The heat regulation water flow flows at least through the main components of the infusion circuit, in particular at least through the electric heater 18 and the infusion unit 11.

Preferably, as shown, the first connection conduit 120, the electric heater 18, the second connection conduit 13, the infusion unit 11, the third connection conduit 15 and the valve unit 35 are connected to be crossed in sequence by the heat regulation water flow.

In the solution shown, the heat regulation water flow can be discharged through the discharge conduit 36 but it is not ruled out that it can be discharged through the dispensing conduit 32 to have greater temperature uniformity along the infusion circuit before starting the extraction step. For the execution of the heat regulation step, the electronic controller 100 activates the electric heater 18 for heating the heat regulation water flow if the value T of the acquired temperature is lower than the initial extraction temperature value Ti.

The electronic controller 100 can regulate the settings of the pump 17 and/or of the electric heater 18 so that the heat regulation water flow can quickly bring the value T of the temperature detected by the sensor means 21 to the initial extraction temperature value Ti.

When, as a result of the thermal exchange between the heat regulation water flow and the components of the infusion circuit, the value T of the temperature detected by the sensor means 21 is brought to the initial extraction temperature value Ti, the heat regulation step ends and the electronic controller 100 can control the execution of the step of introducing the dose of coffee powder into the infusion chamber 12 and then the execution of the extraction step.

Advantageously, the various selectable recipes, and the extraction cycles associated therewith can also be programmable.

Depending on the recipe, the extraction cycles may differ, in addition to the initial extraction temperature value Ti, also in the time trend of the temperature during the extraction step and/or in the trend of the pressure along the infusion circuit also during the extraction step.

Some extraction cycles associated with recipes that can be performed by the coffee machine are shown below.

### Case 1

The heat regulation step depends on the initial extraction cycle temperature value T1 in turn depending on the recipe.

The initial extraction cycle temperature value T1 is set at 25° C., i.e. at room temperature.

The infusion unit 11 has the infusion chamber 12 empty, the exhausted coffee powder having previously been expelled.

The infusion chamber 12 then connects the second connection conduit 13 to the third connection conduit 15.

When acquiring the recipe and identifying the associated extraction cycle, the electronic controller 100 opens the shut-off valve 34 to allow bypassing the cream frother valve 33 and opens the discharge solenoid valve 37 to allow the discharge of water.

The electronic controller 100 acquires the value T of the temperature detected by the temperature sensor means 21 and, if the acquired value T is higher than the initial extraction cycle value T1, then it keeps the electric heater 18 deactivated but it activates the pump 17 which draws water generally at room temperature from the tank 14 or from the water network so as to generate a heat regulation water flow that flows through the infusion circuit and cools it.

The electronic controller 100 deactivates the pump 17 for interrupting the heat regulation water flow when it acquires a temperature value T equal to the initial extraction cycle temperature value T1.

At this point the heat regulation step ends.

The electronic controller 100 does not intervene on the shut-off valve 34 which remains open, but it controls the closing of the discharge solenoid valve 37 in order to connect the infusion unit 11 to the dispensing conduit 32.

The electronic controller 100 controls in sequence the opening of the infusion chamber 12, the loading of the dose of coffee powder, and the closing of the infusion chamber 12 without compression of the dose of coffee powder.

At this point the extraction step begins.

The electronic controller 100 controls the activation of the pump 17 and keeps the electric heater 18 deactivated.

Infusion takes place by keeping the shut-off valve 34 open and the discharge solenoid valve 37 closed.

The pump 17 can be controlled continuously or by pulses depending on the type of aroma to be obtained, in any case guaranteeing a pressure around 1 bar.

Depending on the recipe selected through the machine/user interface, an amount of ice to be added to the product in the cup is recommended.

In this way a “cold brew” coffee of the classic type can be obtained.

The extraction cycle is indicated by the letter A in FIG. 2, where the x axis shows the time and the y axis the temperature detected by the sensor means 21, and where to indicates the instant in which the temperature regulation step ends and the extraction step begins.

### Case 2

Case 2 differs from case 1 in that the initial extraction cycle temperature value T2 is set between 50° C. and 60° C.

The infusion unit 11 has the infusion chamber 12 empty, the exhausted coffee powder having previously been expelled.

The infusion chamber 12 then connects the second connection conduit 13 to the third connection conduit 15.

When acquiring the recipe and identifying the associated extraction cycle, the electronic controller 100 opens the shut-off valve 34 to allow bypassing the cream frother valve 33 and opens the discharge solenoid valve 37 to allow the discharge of water.

The electronic controller 100 acquires the value T of the temperature detected by the temperature sensor means 21 and, if the acquired value T is lower than the initial extraction cycle value T2, then controls the activation of the electric heater 18 as well as of the pump 17 which draws water generally at room temperature from the tank 14 or from the water mains so as to generate a heat regulation water flow that, after being heated by the electric heater 18, flows through the infusion circuit and heats it.

The electronic controller 100 deactivates the pump 17 and the electric heater 18 when it acquires a temperature value T equal to the initial extraction cycle temperature value T2.

At this point the heat regulation step ends.

The electronic controller 100 does not intervene on the shut-off valve 34 which remains open, but it controls the closing of the discharge solenoid valve 37 in order to connect the infusion unit 11 to the dispensing conduit 32.

The electronic controller 100 controls in sequence the opening of the infusion chamber 12, the loading of the dose of coffee powder, and the closing of the infusion chamber 12 without compression of the dose of coffee powder.

At this point the extraction step begins.

The electronic controller 100 activates the pump 17 and the electric heater 18.

Infusion takes place by keeping the shut-off valve 34 open and the discharge solenoid valve 37 closed.

The pump 17 can be controlled by the electronic controller 100 continuously or by pulses depending on the type of aroma to be obtained, in any case guaranteeing a pressure around 1 bar. The electric heater 18 is controlled by the electronic controller 100 in such a way as to keep substantially at the value T2 the temperature detected by the sensor means 21 throughout the extraction step.

Depending on the recipe selected through the machine/user interface, an amount of ice to be added to the product in the cup is recommended.

In this way another type of “cold brew” coffee can be obtained.

The extraction cycle is indicated by the letter B in FIG. 2, where to still indicates the instant in which the heat regulation step ends and the extraction step begins.

### Case 3

Case 3 differs from case 2 in that the initial extraction cycle temperature value T3 is set between 90° C. and 95° C.

The infusion unit 11 has the infusion chamber 12 empty, the exhausted coffee powder having previously been expelled.

The infusion chamber 12 then connects the second connection conduit 13 to the third connection conduit 15.

When acquiring the recipe and identifying the extraction cycle associated with it, the electronic controller 100 opens the shut-off valve 34 to allow bypassing the cream frother valve 33 and opens the drain solenoid valve 37 to allow the discharge of water.

The electronic controller 100 acquires the value T of the temperature detected by the temperature sensor means 21 and, if the acquired value T is lower than the initial extraction cycle value T3, then controls the activation of the electric heater 18 as well as of the pump 17 which draws water generally at room temperature from the tank 14 or from the water mains so as to generate a heat regulation water flow that, after being heated by the electric heater 18, flows through the infusion circuit and heats it.

The electronic controller 100 deactivates the pump 17 and the electric heater 18 when it acquires a temperature value T equal to the initial extraction cycle temperature value T3.

At this point the heat regulation step ends. The electronic controller 100 does not intervene on the shut-off valve 34 which remains open, but it controls the closing of the discharge solenoid valve 37 in order to connect the infusion unit 11 to the dispensing conduit 32.

The electronic controller 100 controls in sequence the opening of the infusion chamber 12, the loading of the dose of coffee powder, and the closing of the infusion chamber 12 without compression of the dose of coffee powder.

At this point the extraction step begins.

The electronic controller 100 activates the pump 17 but keeps the electric heater 18 deactivated. Infusion takes place by keeping the shut-off valve 34 open and the discharge solenoid valve 37 closed.

The pump 17 can be controlled by the electronic controller 100 continuously or by pulses depending on the type of aroma to be obtained, in any case guaranteeing a pressure around 1 bar. Since the electric heater 18 is deactivated, during delivery the detected temperature T will gradually move towards room temperature.

Depending on the recipe selected through the machine/user interface, an amount of ice to be added to the product in the cup is recommended.

In this way another type of “cold brew” coffee can be obtained.

The extraction cycle is indicated by the letter C in FIG. 2, where to still indicates the instant in which the heat regulation step ends and the extraction step begins.

### Case 4

Case 4 differs from case 1 in the extraction step which is performed with the shut-off valve 34 closed so that the first outlet path 27 at high pressure is selected in place of the second outlet path 28 at low pressure.

In this way another type of “cold brew” coffee can be obtained.

### Case 5

Case 5 differs from case 2 in the extraction step which is performed with the shut-off valve 34 closed so that the first outlet path 27 at high pressure is selected in place of the second outlet path 28 at low pressure.

In this way another type of “cold brew” coffee can be obtained.

### Case 6

Case 6 differs from case 3 in the extraction step which is performed with the shut-off valve 34 closed so that the first outlet path 27 at high pressure is selected in place of the second outlet path 28 at low pressure.

In this way another type of “cold brew” coffee can be obtained.

All the extraction cycles set out above may involve drying the exhausted dose of coffee by squeezing it. In particular, the electronic controller 100 can order a relative movement of approach between the piston 25 and the body 24 and the liquid extracted from the exhausted dose of coffee can be conveyed to the discharge conduit 36 simply by switching the discharge solenoid valve 37.

The coffee machine 10 can perform in a versatile manner extraction cycles also of other types, for example an extraction cycle that envisages a compression of the dose of coffee between the piston 25 and the body 24 of the infusion chamber 12, and the execution of the extraction step with an initial cycle value Ti between 90° C. and 95° C. maintained throughout extraction step, with a pump operating at high pressure, for example at least 6 bar, and a shut-off valve 34 closed for extracting an espresso coffee.

More generally, in at least one extraction cycle it can be provided for the extraction step to take place with the electric heater 18 activated for the maintenance of the initial extraction temperature, as illustrated for example in cases 2 and 5 set out above, or for the extraction step to take place with the electric heater 18 deactivated for the gradual descent of the initial extraction temperature, as illustrated for example in cases 3 and 6 set out above.

Finally, according to the invention it is possible to envisage the automatic execution of a coffee machine sanitizing cycle, where the supply pump 17 is activated with the electric heater 18 activated and the infusion chamber 12 is empty for circulating water at a high temperature, for example between 90° C. and 95° C., along the infusion circuit.

The electronic controller 100 of the coffee machine may be programmed to automatically execute a sanitization cycle at each coffee machine switching on and/or if an extraction cycle at high temperature, for example 90° C. and 95° C., has not been selected for a number of consecutive times.

Modifications and/or additions of parts can be made to the described coffee machine and extraction method, without thereby departing from the scope of the present invention as defined by the claims.

1. A coffee extraction method with a coffee machine comprising an infusion circuit at least including a water tank or a connection to a water source, a supply pump, an electric heater and an infusion unit having an infusion chamber where a dose of coffee powder can be positioned, connected in sequence, wherein said machine stores a plurality of selectable extraction cycles each including in sequence an infusion circuit heat regulation step, a step of introducing said dose into said infusion chamber, and a step of extracting coffee having an initial coffee extraction temperature value, and in that at least one extraction cycle comprises the extraction step with an initial extraction temperature value equal to room temperature and with said electric heater deactivated, and in that, after acquiring a selection of a coffee extraction cycle, the coffee machine detects the value of a temperature along the infusion circuit, compares said detected temperature value with the initial extraction temperature value of the selected extraction cycle, and performs the heat regulation step by activating the supply pump to generate a heat regulation water flow in the absence of said dose of coffee in said infusion chamber until said detected temperature value achieves said initial extraction temperature value of the selected extraction cycle.

2. The coffee extraction method according to claim 1, wherein an instant boiler is used as the electric heater.

3. The coffee extraction method according to claim 1, wherein said coffee machine conveys said heat regulation water flow in sequence at least through said electric heater and said infusion unit.

4. The coffee extraction method according to claim 3 wherein said coffee machine conveys said heat regulation water flow towards a discharge conduit positioned downstream of said infusion unit.

5. The coffee extraction method according to claim 1, wherein said coffee machine detects said temperature value at an inlet or an outlet of said electric heater.

6. The coffee extraction method according to claim 1, wherein said coffee machine performs said heat regulation step by activating said electric heater for heating said heat regulation water flow only if said detected temperature value is lower than said initial coffee extraction temperature of the selected coffee extraction cycle.

7. The coffee extraction method according to claim 1, wherein at least one coffee extraction cycle comprises the activation of said electric heater throughout said extraction step for the maintenance of said initial extraction value during said extraction step.

8. The coffee extraction method according to claim 1, wherein at least one coffee extraction cycle comprises the deactivation of said electric heater throughout said extraction step.

9. The coffee extraction method according to claim 1, wherein at least one extraction cycle comprises an initial extraction temperature value comprised between 50° C. and 60° C.

10. The coffee extraction method according to claim 1, wherein at least one extraction cycle comprises an initial extraction temperature value comprised between 90° C. and 95° C.

11. A coffee machine comprising an electronic controller, an infusion circuit and temperature sensor along said infusion circuit, where said infusion circuit comprises a water tank or a connection to a water source, a supply pump, an electric heater and an infusion unit having an infusion chamber where a dose of coffee powder can be positioned, connected in sequence, wherein said electronic controller stores a plurality of selectable coffee extraction cycles each including in sequence an infusion circuit heat regulation step, a step of introducing said dose into said infusion chamber, and a coffee extraction step having an initial coffee extraction temperature value, in that at least one extraction cycle comprises the extraction step with an initial extraction temperature value equal to room temperature and with said electric heater deactivated, and in that said electronic controller is configured to:
acquire a selection of a coffee extraction cycle;
acquire the value of the temperature detected by said temperature sensor;
compare said detected temperature value with the initial extraction temperature value of the selected extraction cycle; and
perform said heat regulation step by activating the supply pump for generating a heat regulation water flow in the absence of said dose of coffee in said infusion chamber until said detected temperature value achieves said initial extraction temperature value of the selected extraction cycle.

12. The coffee machine according to claim 11, wherein said electric heater consists of an instant boiler.

13. The coffee machine according to claim 11, wherein said infusion circuit further comprises a coffee infusion dispensing conduit, a first connection conduit between the delivery of the supply pump and an inlet of the electric heater, a second connection conduit between an outlet of the electric heater and an inlet of the infusion unit, a valve unit, a third connection conduit between an outlet of the infusion unit and an inlet of the valve unit, said valve unit being configured to provide a first outlet path at high pressure comprising a back pressure and a second outlet path at low pressure comprising a bypass selectively activatable by the electronic controller for bypassing the action of said back pressure and making the beverage pass into said second outlet path.

14. The coffee machine according to claim 13, wherein said first connection conduit, said electric heater, said second connection conduit, said infusion unit, said third connection conduit and said valve unit are connected to be crossed in sequence by said heat regulation water flow.
